(19) United States
(12) Patent Application Publication
(10) Pub. No.: US 2026/0082464 A1
(43) Pub. Date: Mar. 19, 2026

(54) LIGHT-EMITTING DIODE DEVICE

(71) Applicant: Lextar Electronics Corporation, Hsinchu City (TW)

(72) Inventors: Yu-Ping HUNG, Hsinchu City (TW); Wei-Chieh WENG, Hsinchu City (TW); Zong-Han YU, Hsinchu City (TW); Cheng-Yi LIU, Hsinchu City (TW); Wen-Syun WANG, Hsinchu City (TW); Chuan-Chi WEI, Hsinchu City (TW)

(21) Appl. No.: 19/193,833

(22) Filed: Apr. 29, 2025

(30) Foreign Application Priority Data
Sep. 18, 2024 (TW) 113135187

(51) Int. Cl. H05B 45/20

(52) U.S. Cl. CPC H05B 45/20

(57) ABSTRACT

A light-emitting diode device includes light-emitting diodes, a storage module, a control module, a driving module, and a package structure. The light-emitting diodes emit different colors of light. The storage module pre-stores color coordinate reference information and brightness reference information corresponding to a current/voltage of the light-emitting diodes. The control module receives the color coordinate reference information and the brightness reference information corresponding to the light-emitting diodes, and uses the color coordinate reference information, the brightness reference information, the color coordinate requirement information, and the brightness requirement information according to a light mixing algorithm to generate a first control signal. The driving module generates a driving signal according to the first control signal to drive the light-emitting diodes to emit a light having a color coordinate and brightness that meet requirements. The package structure accommodates the light-emitting diodes, the storage module, the control module, and the driving module.

### CROSS REFERENCE TO RELATED APPLICATIONS

This application claims priority TW patent application No. 113135187, filed on Sep. 18, 2024, the entirety of which is incorporated by reference herein.

### BACKGROUND OF THE DISCLOSURE

### Field of the Disclosure

The disclosure relates to a light-emitting device, and in particular, to a light-emitting diode device.

### Description of the Related Art

In the current production process of light-emitting diodes (LEDs), LEDs are usually classified according to product requirements. For example, LEDs are classified into different bins according to their photoelectric characteristics. However, the classification process is time-consuming and increases the cost burden.

Furthermore, for light-emitting devices that require light-emitting diodes with different colors, such as the light emitting devices including red LEDs, green LEDs and blue LEDs, in terms of color calibration, the red LEDs, the green LEDs and the blue LEDs are also needed to be classified separately in advance, and the red LEDs, the green LEDs and the blue LEDs with specific wavelength ranges are selected for light mixing, so as to achieve the desired light color. However, the ensuing problem is that the cost of component screening increases, and the remaining unused LEDs cannot be consumed, resulting in inventory accumulation.

### BRIEF SUMMARY OF THE DISCLOSURE

The disclosure provides a light-emitting diode device, thereby improving the traditional shortcomings of needing to spend a lot of time in advance to classify the light-emitting diodes (for example, LED binning) and then select appropriate light-emitting diodes for packing in light-emitting devices, saving LED component screening costs and reducing LED inventory, improving the production yield and simplicity of surface mount technology (SMT), so as to increase the convenience of use.

An embodiment of the disclosure provides a light-emitting diode device, which includes a plurality of light-emitting diodes, a storage module, a control module, a driving module, and a package structure. The light-emitting diodes are configured to emit different colors of light. The storage module is configured to pre-store color coordinate reference information and brightness reference information corresponding to a current/voltage of the light-emitting diodes. The control module is coupled to the storage module. The control module is configured to receive color coordinate requirement information and brightness requirement information corresponding to the light-emitting diodes, and generate a first control signal based on the color coordinate reference information, the brightness reference information, the color coordinate requirement information, and the brightness requirement information according to a light mixing algorithm. The driving module is coupled to the light-emitting diodes and the control module. The driving module is configured to generate a driving signal according to the first control signal, so as to drive the light-emitting diodes to emit a light having a color coordinate and brightness that meet requirements. The package structure is configured to accommodate the light-emitting diodes, the storage module, the control module, and the driving module.

According to the light-emitting diode device disclosed by the present disclosure, the storage module pre-stores the color coordinate reference information and the brightness reference information corresponding to the current/voltage of the light-emitting diodes. The control module receives the color coordinate requirement information and the brightness requirement information corresponding to the light-emitting diodes, and uses the color coordinate reference information, the brightness reference information, the color coordinate requirement information, and the brightness requirement information according to the light mixing algorithm to generate the first control signal. The driving module generates the driving signal according to the first control signal, so as to drive the light-emitting diodes to emit a light having a color coordinate and brightness that meet requirements. Therefore, the light-emitting diode device of the disclosure performs color calibration through real-time calculation, providing users with real-time and reliable color (light) adjustment combinations, thereby improving the traditional shortcomings of needing to spend a lot of time in advance to classify the light-emitting diodes (for example, binning) and then select appropriate light-emitting diodes for packing in light-emitting devices, saving LED component screening costs and reducing LED inventory, improving the production yield and simplicity of surface mount technology. There is no need to perform complicated color calibration and white balance adjustment in advance, so as to increase the convenience of use.

### BRIEF DESCRIPTION OF THE DRAWINGS

The disclosure can be fully understood by reading the subsequent detailed description and examples with references made to the accompanying drawings, wherein:

FIG. 1 is a block diagram of a light-emitting diode device according to an embodiment of the disclosure;

FIG. 2 is a schematic view of a configuration relationship of a light-emitting diode device according to an embodiment of the disclosure;

FIG. 3 is a block diagram of a light-emitting diode device according to another embodiment of the disclosure; and

FIG. 4 is a schematic view of a configuration relationship of a light-emitting diode device according to another embodiment of the disclosure.

### DETAILED DESCRIPTION OF THE DISCLOSURE

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, a person skilled in the art would selectively implement all or some technical features of any embodiment of the disclosure or selectively combine all or some technical features of the embodiments of the disclosure.

In each of the following embodiments, the same reference number represents the same or a similar element or component.

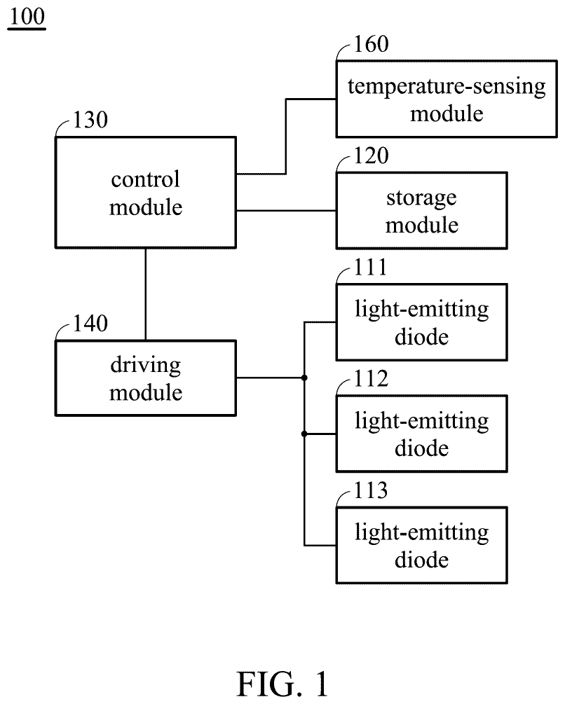

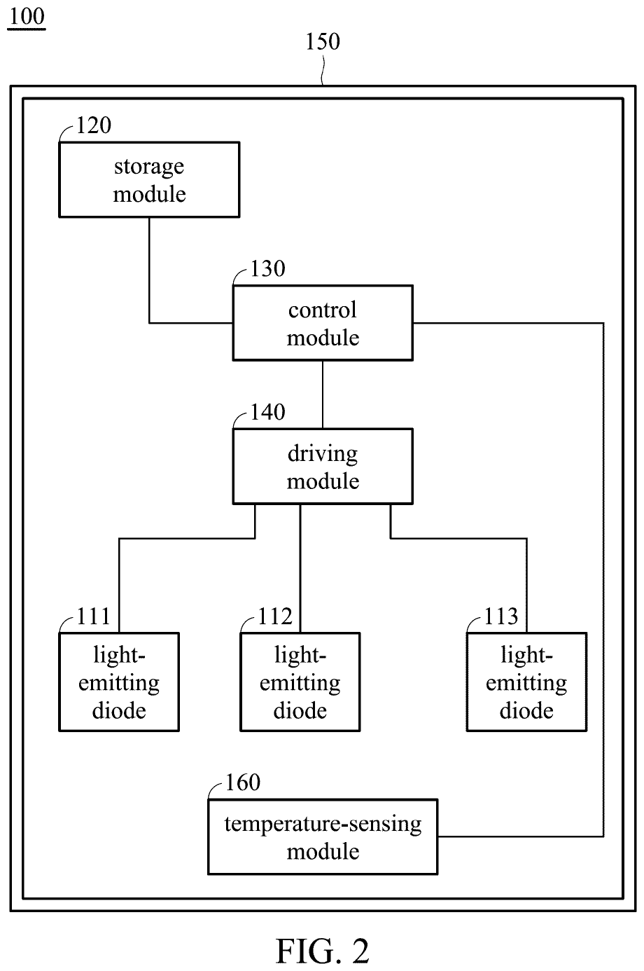

FIG. 1 is a block diagram of a light-emitting diode device according to an embodiment of the disclosure. FIG. 2 is a schematic view of a configuration relationship of a light-emitting diode device according to an embodiment of the disclosure. The light-emitting diode device 100 of the disclosure may be applied to a lighting lamp, and widely used to a car interior light source, a roof reading lighting, an instrument panel lighting, and car ambient lighting for creating atmosphere, etc., but the disclosure is not limited thereto. Please refer to FIG. 1 and FIG. 2. The light-emitting diode device 100 includes a plurality of light-emitting diodes 111, 112 and 113, a storage module 120, a control module 130, a driving module 140 and a package structure 150.

The light-emitting diodes 111, 112 and 113 may emit different colors of light. In some embodiments, the light-emitting diodes 111, 112 and 113 may include a red light-emitting diode, a green light-emitting diode and a blue light-emitting diode. In the embodiment, the light-emitting diode 111 may be the red light-emitting diode, the light-emitting diode 112 may be the green light-emitting diode, and the light-emitting diode 113 may be the blue light-emitting diode, but the disclosure is not limited thereto. In addition, the above different colors of light may include a red light, a green light and a blue light, but the disclosure is not limited thereto.

The storage module 120 may pre-store color coordinate reference information and brightness reference information corresponding to a current/voltage of the light-emitting diodes 111, 112 and 113. In some embodiments, the above color coordinate reference information may include a predetermined red light X-axis color coordinate value, a predetermined red light Y-axis color coordinate value, a predetermined green light X-axis color coordinate value, a predetermined green light Y-axis color coordinate value, a predetermined blue light X-axis color coordinate value and a predetermined blue light Y-axis color coordinate value, and the brightness requirement information may include a predetermined red light intensity value, a predetermined green light intensity value and a predetermined blue light intensity value, but the disclosure is not limited thereto. In some embodiments, the storage module 120 may be a memory or another suitable storage device, but the disclosure is not limited thereto.

The control module 130 is coupled to the storage module 120. The control module 130 may receive color coordinate requirement information and brightness requirement information corresponding to the light-emitting diodes 111, 112 and 113 from a user input. In some embodiments, the control module 130 may be a central processing unit (CPU), a micro control unit (MCU), a microprocessor or another suitable controller, but the disclosure is not limited thereto.

Furthermore, the control module 130 may use the color coordinate reference information, the brightness reference information, the color coordinate requirement information, and the brightness requirement information according to a light mixing algorithm to generate a first control signal. In some embodiments, the above color coordinate requirement information may include an X-axis color coordinate value and a Y-axis color coordinate value, and the above brightness requirement information may include a desired light intensity value, but the disclosure is not limited thereto. In addition, the user may set the above color coordinate requirement information and the above brightness requirement information according to the user's requirement, so that the control module 130 may perform subsequent corresponding operations according to the set color coordinate requirement information and the set brightness requirement information.

In some embodiments, the control module 130 may calculate a desired red light intensity value, a desired green light intensity value and a desired blue light intensity value according to the light mixing algorithm. Furthermore, the control module 130 may convert the X-axis color coordinate value, the Y-axis color coordinate value and the desired light intensity value into a first stimulation value, a second stimulation value and a third stimulation value. Then, the control module 130 may substitute the first stimulation value, the second stimulation value, the third stimulation value, the predetermined red light X-axis color coordinate value, the predetermined red light Y-axis color coordinate value, the predetermined green light X-axis color coordinate value, the predetermined green light Y-axis color coordinate value, the predetermined blue light X-axis color coordinate value, and the predetermined blue light Y-axis color coordinate value into the following equations (1), (2) and (3) of the light mixing algorithm, so as to obtain the desired red light intensity value, the desired green light intensity value and the desired blue light intensity value.

$${I}_{{r\_desired}^{}} * {x}_{r} / {y}_{r} + {I}_{g\_desired} * {x}_{g} / {y}_{g} + {I}_{b\_desired} * {x}_{b} / {y}_{b} = X \qquad ( 1 )$$

$${I}_{{r\_desired}^{}} + {I}_{g\_desired} + {I}_{b\_desired} = Y \qquad ( 2 )$$

$${I}_{r\_desired} ( 1 - {x}_{r} - {y}_{r} ) / {y}_{r} + {I}_{g\_desired} ( 1 - {x}_{g} - {y}_{g} ) / {y}_{g} + {I}_{b\_desired} ( 1 - {x}_{b} - {y}_{b} ) / {y}_{b} = Z \qquad ( 3 )$$

X is the first stimulation value, Y is the second stimulation value, Z is the third stimulation value, xᵣ is the predetermined red light X-axis color coordinate value, yᵣ is the predetermined red light Y-axis color coordinate value, x_{g} is the predetermined green light X-axis color coordinate value, y_{g} is the predetermined green light Y-axis color coordinate value, x_{b} is the predetermined blue light X-axis color coordinate value, y_{b} is the predetermined blue light Y-axis color coordinate value, I_{r_desired} is the desired red light intensity value, I_{g_desired} is the desired green light intensity value, and I_{b_desired} is the desired blue light intensity value.

Then, the control module 130 may calculate a first duty cycle of a first pulse width modulation signal corresponding to the red light-emitting diode (i.e., the light-emitting diode 111) according to the desired red light intensity value and the predetermined red light intensity value, calculate a second duty cycle of a second pulse width modulation signal corresponding to the green light-emitting diode (i.e., the light-emitting diode 112) according to the desired green light intensity value and the predetermined green light intensity value, and calculate a third duty cycle of a third pulse width modulation signal corresponding to the blue light-emitting diode (i.e., the light-emitting diode 113) according to the desired blue light intensity value and the predetermined blue light intensity value.

For example, the control module 130 may divide the desired red light intensity value by the predetermined red light intensity value to calculate the first duty cycle of the first pulse width modulation signal. The control module 130 may divide the desired green light intensity value by the predetermined green light intensity value to calculate the second duty cycle of the second pulse width modulation signal. The control module 130 may divide the desired blue light intensity value by the predetermined blue light intensity value to calculate the third duty cycle of the third pulse width modulation signal.

The driving module 140 is coupled to the light-emitting diodes 111, 112 and 113 and the control module 130. The driving module 140 may generate a driving signal according to the first control signal, so as to drive the light-emitting diodes 111, 112 and 113 to emit a light having a color coordinate and brightness that meet requirements.

In some embodiments, the driving module 140 may generate the corresponding driving signal according to the first duty cycle of the first pulse width modulation signal, the second duty cycle of the second pulse width modulation signal and the third duty cycle of the third pulse width modulation signal, so as to respectively drive the red light-emitting diode (i.e., the light-emitting diode 111), the green light-emitting diode (i.e., the light-emitting diode 112) and the blue light-emitting diode (i.e., the light-emitting diode 113).

The package structure 150 may be configured to accommodate the light-emitting diodes 111, 112 and 113, the storage module 120, the control module 130 and the driving module 140. In some embodiments, the package structure 150 may be a housing, but the disclosure is not limited thereto.

In some embodiments, the storage module 120 may further pre-store thermal characteristic information of the light-emitting diodes 111, 112 and 113, i.e., the storage module 120 may pre-store the color coordinate reference information, the brightness reference information and the thermal characteristic information. In addition, light-emitting diode device 100 may further include a temperature-sensing module 160. The temperature-sensing module 160 is accommodated in the package structure 150.

The temperature-sensing module 160 may sense the temperature of the light-emitting diodes 111, 112 and 113 to generate a temperature signal. In some embodiments, the temperature-sensing module 160 may be a thermistor or another suitable temperature sensor, but the disclosure is not limited thereto.

The control module 130 may receive the temperature signal generated by the temperature-sensing module 160, and use the temperature signal and the thermal characteristic information of the light-emitting diodes according to the thermal decay compensation algorithm to generate a second control signal. Then, the driving module 140 may further adjust the driving signal according to the second control signal, and provide the adjusted driving signal to the light-emitting diodes 111, 112 and 113, so as to compensate the brightness of the light-emitting diodes 111, 112 and 113 according to the temperature change. That is, with the detection of the internal temperature, the loss of the light intensity of the light-emitting diodes 111, 112 and 113 caused by the thermal decay may be immediately reinforced, so as to maintain the color from drifting.

In some embodiments, the above thermal characteristic information may include a corresponding relationship between the temperature and the brightness of the light-emitting diodes 111, 112 and 113, but the disclosure is not limited thereto. In some embodiments, the control module 130 may calculate a red light intensity thermal decay compensation value ΔIᵣ, a green light intensity thermal decay compensation value ΔI_{g} and a blue light intensity thermal decay compensation value ΔI_{g} according to the temperature signal and the thermal decay compensation algorithm.

In some embodiments, the above thermal decay compensation algorithm includes equations (4) and (5).

$${I}_{r , g , b} ( T ) = a T + b \qquad ( 4 )$$

$$Δ {I}_{r , g , b} = {I}_{r , g , b} ( Ts ) - {I}_{r , g , b} ( T ) \qquad ( 5 )$$

In the above equations a is a slope, b is an offset value, T is a temperature corresponding to the light-emitting diodes 111, 112 and 113, I_{r,g,b}(T) denotes a thermal decay light intensity value corresponding to the red light-emitting diode (i.e., the light-emitting diode 111), the green light-emitting diode (i.e., the light-emitting diode 112) and the blue light-emitting diode (i.e., the light-emitting diode 113) at the temperature T, i.e., Iᵣ(T), I_{g}(T) and I_{b}(T) respectively. Ts is a criterion temperature. I_{r,g,b}(Ts) denotes a criterion red light intensity value Iᵣ(Ts), a criterion green light intensity value I_{g}(Ts) and a criterion blue light intensity value I_{b}(Ts) corresponding to the red light-emitting diode (i.e., the light-emitting diode 111), the green light-emitting diode (i.e., the light-emitting diode 112) and the blue light-emitting diode (i.e., the light-emitting diode 113) at the criterion temperature Ts. ΔI_{r,g,b} denotes the red light intensity thermal decay compensation value ΔIᵣ, the green light intensity thermal decay compensation value ΔI_{g} and the blue light intensity thermal decay compensation value ΔI_{b}. In some embodiments, the criterion temperature Ts is 25° C.

In some embodiments, according to the relationship between the light intensity value of the red light-emitting diode (i.e., the light-emitting diode 111) and the temperature T, a is −0.0074, and b is 1.0169. In some embodiments, according to the relationship between the light intensity value of the green light-emitting diode (i.e., the light-emitting diode 112) and the temperature T, a is −0.0013, and b is 1.0049. In some embodiments, according to the relationship between the light intensity value of the blue light-emitting diode (i.e., the light-emitting diode 113) and the temperature T, a is 0.0009, and b is 0.8678.

Then, the control module 130 may generate a first duty cycle compensation value corresponding to the first pulse width modulation signal of the red light-emitting diode (i.e., the light-emitting diode 111), a second duty cycle compensation value corresponding to the second pulse width modulation signal of the green light-emitting diode (i.e., the light-emitting diode 112) and a third duty cycle compensation value corresponding to the third pulse width modulation signal of the blue light-emitting diode (i.e., the light-emitting diode 113) for the second control signal according to the red light intensity thermal decay compensation value ΔIᵣ, the green light intensity thermal decay compensation value ΔI_{g} and the blue light intensity thermal decay compensation value ΔIᵣ.

Furthermore, in some embodiments, the control module 130 may calculate the first duty cycle compensation value corresponding to the first pulse width modulation signal of the red light-emitting diode (i.e., the light-emitting diode 111), the second duty cycle compensation value corresponding to the second pulse width modulation signal of the green light-emitting diode (i.e., the light-emitting diode 112) and the third duty cycle compensation value corresponding to the third pulse width modulation signal of the blue light-emitting diode (i.e., the light-emitting diode 113) according to a ratio of the red light intensity thermal decay compensation value to the criterion red light intensity value, a ratio of the green light intensity thermal decay compensation value to the criterion green light intensity value and a ratio of the blue light intensity thermal decay compensation value to the criterion blue light intensity value.

For example, the control module 130 may divide the red light intensity thermal decay compensation value by the criterion red light intensity value to calculate the first duty cycle compensation value of the first pulse width modulation signal. The control module 130 may divide the green light intensity thermal decay compensation value by the criterion green light intensity value to calculate the second duty cycle compensation value of the second pulse width modulation signal. The control module 130 may divide the blue light intensity thermal decay compensation value by the criterion blue light intensity value to calculate the third duty cycle compensation value of the third pulse width modulation signal.

Afterward, the driving module 140 may adjust the driving signal according to the first duty cycle compensation value corresponding to the first pulse width modulation signal of the red light-emitting diode (i.e., the light-emitting diode 111), the second duty cycle compensation value corresponding to the second pulse width modulation signal of the green light-emitting diode (i.e., the light-emitting diode 112) and the third duty cycle compensation value corresponding to the third pulse width modulation signal of the blue light-emitting diode (i.e., the light-emitting diode 113).

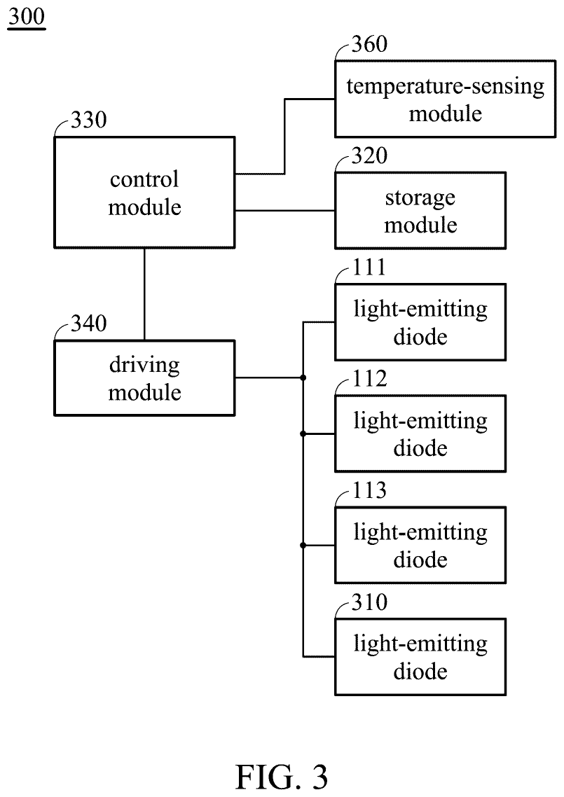

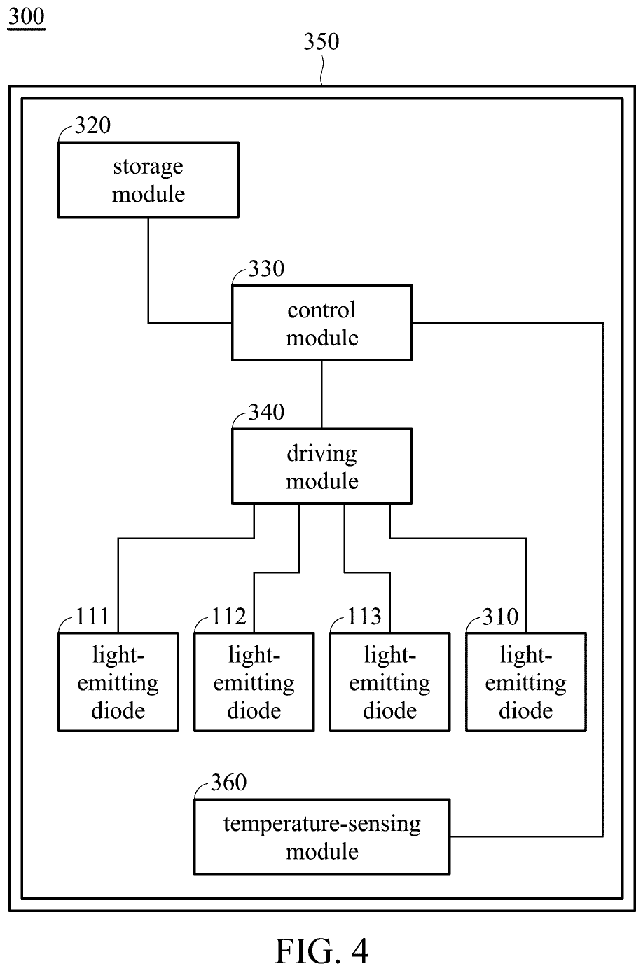

FIG. 3 is a block diagram of a light-emitting diode device according to another embodiment of the disclosure. FIG. 4 is a schematic view of a configuration relationship of a light-emitting diode device according to another embodiment of the disclosure. The light-emitting diode device 300 of the disclosure may be applied to a lighting lamp, and widely used to a car ambient light source, a roof reading light lighting, an instrument panel display lighting, and car interior situation lighting, etc., but the disclosure is not limited thereto. Please refer to FIG. 3 and FIG. 4. The light-emitting diode device 300 includes a plurality of light-emitting diodes 111, 112, 113 and 310, a storage module 320, a control module 330, a driving module 340, a package structure 350 and a temperature-sensing module 360.

In the embodiments, the light-emitting diodes 111, 112 and 113 in FIG. 3 and FIG. 4 are the same as or similar to the light-emitting diodes 111, 112 and 113 in FIG. 1 and FIG. 2. Accordingly, the light-emitting diodes 111, 112 and 113 in FIG. 3 and FIG. 4 may refer to the description of the embodiments of FIG. 1 and FIG. 2, and the description thereof is not repeated herein. In some embodiments, the light-emitting diode 310 may be a cyan light-emitting diode or a white light-emitting diode, but the disclosure is not limited thereof. In addition, the different colors of light may further include a cyan light or a white light, but the disclosure is not limited thereto.

The storage module 320 may pre-store color coordinate reference information and brightness reference information corresponding to a current/voltage of the light-emitting diodes 111, 112, 113 and 310. In some embodiments, the above color coordinate reference information may include a predetermined red light X-axis color coordinate value, a predetermined red light Y-axis color coordinate value, a predetermined green light X-axis color coordinate value, a predetermined green light Y-axis color coordinate value, a predetermined blue light X-axis color coordinate value, a predetermined blue light Y-axis color coordinate value, a predetermined cyan or white light X-axis color coordinate value and a predetermined cyan or white light Y-axis color coordinate value, and the brightness requirement information may include a predetermined red light intensity value, a predetermined green light intensity value and a predetermined blue light intensity value and a predetermined cyan or white light intensity value, but the disclosure is not limited thereto. In some embodiments, the storage module 320 may be a memory or another suitable storage device, but the disclosure is not limited thereto.

The control module 330 is coupled to the storage module 320. The control module 330 may receive color coordinate requirement information and brightness requirement information corresponding to the light-emitting diodes 111, 112, 113 and 310. In some embodiments, the control module 330 may be a central processing unit, a micro control unit, a microprocessor or another suitable controller, but the disclosure is not limited thereto.

Furthermore, the control module 330 may use the color coordinate reference information, the brightness reference information, the color coordinate requirement information, and the brightness requirement information according to a light mixing algorithm to generate a first control signal. In some embodiments, the above color coordinate requirement information may include an X-axis color coordinate value and a Y-axis color coordinate value, and the above brightness requirement information may be a desired light intensity value, but the disclosure is not limited thereto. In addition, the user may set the above color coordinate requirement information and the above brightness requirement information according to the requirement thereof, so that the control module 330 may perform subsequent corresponding operations according to the set color coordinate requirement information and the set brightness requirement information.

In some embodiments, the control module 330 may calculate a desired red light intensity value, a desired green light intensity value, a desired blue light intensity value and a desired cyan or white light intensity value according to the light mixing algorithm. Furthermore, the control module 330 may convert the X-axis color coordinate value, the Y-axis color coordinate value and the desired light intensity value into a first stimulation value, a second stimulation value and a third stimulation value. Then, the control module 330 may substitute the first stimulation value, the second stimulation value, the third stimulation value, the predetermined red light X-axis color coordinate value, the predetermined red light Y-axis color coordinate value, the predetermined green light X-axis color coordinate value, the predetermined green light Y-axis color coordinate value, the predetermined blue light X-axis color coordinate value, the predetermined blue light Y-axis color coordinate value, the predetermined cyan or white light X-axis color coordinate value and the predetermined cyan or white light Y-axis color coordinate value into the following equations (6), (7) and (8) of the light mixing algorithm, so as to obtain the desired red light intensity value, the desired green light intensity value, the desired blue light intensity value and the desired cyan or desired white light intensity value.

$${I}_{{r\_desired}^{}} * {x}_{r} / {y}_{r} + {I}_{g\_desired} * {x}_{g} / {y}_{g} + {I}_{b\_desired} * {x}_{b} / {y}_{b} * {I}_{c , w\_desired} * {x}_{c , w} / {y}_{c , w} = X \qquad ( 6 )$$

$${I}_{{r\_desired}^{}} + {I}_{g\_desired} + {I}_{b\_desired} + {I}_{c , w\_desired} = Y \qquad ( 7 )$$

$${I}_{r\_desired} ( 1 - {x}_{r} - {y}_{r} ) / {y}_{r} + {I}_{g\_desired} ( 1 - {x}_{g} - {y}_{g} ) / {y}_{g} + {I}_{b\_desired} ( 1 - {x}_{b} - {y}_{b} ) / {y}_{b} + {I}_{c , w\_desired} ( 1 - {x}_{c , w} - {y}_{c , w} ) / {y}_{c , w} = Z \qquad ( 8 )$$

X is the first stimulation value, Y is the second stimulation value, Z is the third stimulation value, xᵣ is the predetermined red light X-axis color coordinate value, yᵣ is the predetermined red light Y-axis color coordinate value, x_{g} is the predetermined green light X-axis color coordinate value, y_{g} is the predetermined green light Y-axis color coordinate value, x_{b} is the predetermined blue light X-axis color coordinate value, y_{b} the predetermined blue light Y-axis color coordinate value, x_{c,w} the predetermined cyan or white light X-axis color coordinate value, y_{c,w} the predetermined cyan or white light Y-axis color coordinate value, I_{r_desired} is the desired red light intensity value, I_{g_desired} is the desired green light intensity value, I_{b} desired is the desired blue light intensity value, and I_{c,w_desired} is the desired cyan or white light intensity value.

Then, the control module 330 may calculate a first duty cycle of a first pulse width modulation signal corresponding to the red light-emitting diode (i.e., the light-emitting diode 111) according to the desired red light intensity value and the predetermined red light intensity value, calculate a second duty cycle of a second pulse width modulation signal corresponding to the green light-emitting diode (i.e., the light-emitting diode 112) according to the desired green light intensity value and the predetermined green light intensity value, calculate a third duty cycle of a third pulse width modulation signal corresponding to the blue light-emitting diode (i.e., the light-emitting diode 113) according to the desired blue light intensity value and the predetermined blue light intensity value, and calculate a fourth duty cycle of a fourth pulse width modulation signal corresponding to the cyan or white light-emitting diode (i.e., the light-emitting diode 310) according to the desired cyan light intensity value and the predetermined cyan light intensity value or according to the desired white light intensity value and the predetermined white light intensity value.

For example, the control module 330 may divide the desired red light intensity value by the predetermined red light intensity value to calculate the first duty cycle of the first pulse width modulation signal. The control module 330 may divide the desired green light intensity value by the predetermined green light intensity value to calculate the second duty cycle of the second pulse width modulation signal. The control module 330 may divide the desired blue light intensity value by the predetermined blue light intensity value to calculate the third duty cycle of the third pulse width modulation signal. The control module 330 may divide the desired cyan light intensity value by the predetermined cyan light intensity value or divide the desired white light intensity value by the predetermined white light intensity value to calculate the fourth duty cycle of the fourth pulse width modulation signal.

The driving module 340 is coupled to the light-emitting diodes 111, 112, 113 and 310 and the control module 330. The driving module 340 may generate a driving signal according to the first control signal, so as to drive the light-emitting diodes 111, 112, 113 and 310 to emit a light having a color coordinate and brightness that meet requirements.

In some embodiments, the driving module 340 may generate the corresponding driving signal according to the first duty cycle of the first pulse width modulation signal, the second duty cycle of the second pulse width modulation signal, the third duty cycle of the third pulse width modulation signal and the fourth duty cycle of the fourth pulse width modulation signal, so as to respectively drive the red light-emitting diode (i.e., the light-emitting diode 111), the green light-emitting diode (i.e., the light-emitting diode 112), the blue light-emitting diode (i.e., the light-emitting diode 113) and the cyan or white light-emitting diode (i.e., the light-emitting diode 310).

The package structure 350 may be configured to accommodate the light-emitting diodes 111, 112, 113 and 310, the storage module 320, the control module 330, the driving module 340 and the temperature-sensing module 360. In some embodiments, the package structure 350 may be a housing, but the disclosure is not limited thereto.

In some embodiments, the storage module 320 may further pre-store thermal characteristic information of the light-emitting diodes 111, 112, 113 and 310, i.e., the storage module 320 may pre-store the color coordinate reference information, the brightness reference information and the thermal characteristic information.

The temperature-sensing module 360 may sense the temperature of the light-emitting diodes 111, 112, 113 and 310 to generate a temperature signal. In some embodiments, the temperature-sensing module 360 may be a thermistor or another suitable temperature sensor, but the disclosure is not limited thereto.

The control module 330 may receive the temperature signal generated by the temperature-sensing module 360, and use the temperature signal and the thermal characteristic information of the light-emitting diodes according to the thermal decay compensation algorithm to generate a second control signal. Then, the driving module 340 may adjust the driving signal according to the second control signal, and provide the adjusted driving signal to the light-emitting diodes 111, 112, 113 and 310, so as to compensate the brightness of the light-emitting diodes 111, 112, 113 and 310 according to the temperature change. That is, with the detection of the internal temperature, the loss of the light intensity of the light-emitting diodes 111, 112, 113 and 310 caused by the thermal decay may be immediately reinforced, so as to maintain the color from drifting.

In some embodiments, the above thermal characteristic information may include a corresponding relationship between the temperature and the brightness of the light-emitting diodes 111, 112, 113 and 310, but the disclosure is not limited thereto. In some embodiments, the control module 330 may calculate a red light intensity thermal decay compensation value ΔIᵣ, a green light intensity thermal decay compensation value ΔI_{g}, a blue light intensity thermal decay compensation value ΔI_{b} and a cyan light intensity thermal decay compensation value ΔI_{c} or the white light intensity thermal decay compensation value ΔI_{w} according to the temperature signal and the thermal decay compensation algorithm.

In some embodiments, the above thermal decay compensation algorithm includes equations (9) and (10).

$${I}_{r , g , b , c , w} ( T ) = a T + b \qquad ( 9 )$$

$$Δ {I}_{r , g , b , c , w} = {I}_{r , g , b , c , w} ( Ts ) - {I}_{r , g , b , c , w} ( T ) \qquad ( 10 )$$

In the above equations, a is a slope, b is an offset value, T is a temperature corresponding to the light-emitting diodes 111, 112, 113 and 330, I_{r,g,b,c,w}(T) denotes a thermal decay light intensity value corresponding to the red light-emitting diode (i.e., the light-emitting diode 111), the green light-emitting diode (i.e., the light-emitting diode 112), the blue light-emitting diode (the light-emitting diode 113) and the cyan or white light-emitting diode (i.e., the light-emitting diode 310) at the temperature T, i.e., Iᵣ(T), I_{g}(T), I_{b}(T) and I_{c}(T) or I_{w}(T) respectively. Ts is a criterion temperature, I_{r,g,b,c,w}(Ts) denotes a criterion red light intensity value Iᵣ(Ts), a criterion green light intensity value I_{g}(Ts), a criterion blue light intensity value I_{b}(Ts) and a criterion cyan light intensity value I_{c}(Ts) or a criterion white light intensity value I_{w}(Ts) corresponding to the red light-emitting diode (i.e., the light-emitting diode 111), the green light-emitting diode (i.e., the light-emitting diode 112), the blue light-emitting diode (i.e., the light-emitting diode 113) and the cyan or white light-emitting diode (i.e., the light-emitting diode 310) at the criterion temperature Ts. ΔI_{r,g,b,c,w} denotes the red light intensity thermal decay compensation value ΔIᵣ, the green light intensity thermal decay compensation value ΔI_{g}, the blue light intensity thermal decay compensation value ΔI_{b} and the cyan light intensity thermal decay compensation value ΔI_{c} or the white light intensity thermal decay compensation value ΔI_{w}.

Then, the control module 330 may generate a first duty cycle compensation value corresponding to the first pulse width modulation signal of the red light-emitting diode (i.e., the light-emitting diode 111), a second duty cycle compensation value corresponding to the second pulse width modulation signal of the green light-emitting diode (i.e., the light-emitting diode 112), a third duty cycle compensation value corresponding to the third pulse width modulation signal of the blue light-emitting diode (i.e., the light-emitting diode 113) and a fourth duty cycle compensation value corresponding to the fourth pulse width modulation signal of the cyan or white light-emitting diode (i.e., the light-emitting diode 310) of the second control signal according to the red light intensity thermal decay compensation value ΔIᵣ, the green light intensity thermal decay compensation value ΔIᵣ, the blue light intensity thermal decay compensation value ΔI_{b} and the cyan light intensity thermal decay compensation value ΔI_{c} or the white light intensity thermal decay compensation value ΔI_{w}.

Furthermore, in some embodiments, the control module 330 may calculate the first duty cycle compensation value corresponding to the first pulse width modulation signal of the red light-emitting diode (i.e., the light-emitting diode 111), the second duty cycle compensation value corresponding to the second pulse width modulation signal of the green light-emitting diode (i.e., the light-emitting diode 112), the third duty cycle compensation value corresponding to the third pulse width modulation signal of the blue light-emitting diode (i.e., the light-emitting diode 113) and the fourth duty cycle compensation value corresponding to the fourth pulse width modulation signal of the cyan or white light-emitting diode (i.e., the light-emitting diode 310) according to a ratio of the red light intensity thermal decay compensation value to the criterion red light intensity value, a ratio of the green light intensity thermal decay compensation value to the criterion green light intensity value, a ratio of the blue light intensity thermal decay compensation value to the criterion blue light intensity value and a ratio of the cyan light intensity thermal decay compensation value to the criterion cyan light intensity value or a ratio of the white light intensity thermal decay compensation value to the criterion white light intensity value.

For example, the control module 330 may divide the red light intensity thermal decay compensation value by the criterion red light intensity value to calculate the first duty cycle compensation value of the first pulse width modulation signal. The control module 330 may divide the green light intensity thermal decay compensation value by the criterion green light intensity value to calculate the second duty cycle compensation value of the second pulse width modulation signal. The control module 330 may divide the blue light intensity thermal decay compensation value by the criterion blue light intensity value to calculate the third duty cycle compensation value of the third pulse width modulation signal. The control module 330 may divide the cyan or white light intensity thermal decay compensation value by the criterion cyan or white light intensity value to calculate the fourth duty cycle compensation value of the fourth pulse width modulation signal.

Afterward, the driving module 340 may adjust the driving signal according to the first duty cycle compensation value corresponding to the first pulse width modulation signal of the red light-emitting diode (i.e., the light-emitting diode 111), the second duty cycle compensation value corresponding to the second pulse width modulation signal of the green light-emitting diode (i.e., the light-emitting diode 112), the third duty cycle compensation value corresponding to the third pulse width modulation signal of the blue light-emitting diode (i.e., the light-emitting diode 113) and the fourth duty cycle compensation value corresponding to the fourth pulse width modulation signal of the cyan or white light-emitting diode (i.e., the light-emitting diode 310).

Therefore, the light-emitting diode device of the disclosure integrates the storage module, the control module, and the driving module in a package structure to perform color calibration of the light-emitting diode in real time.

In summary, according to the light-emitting diode device disclosed by the embodiments of the disclosure, the storage module pre-stores the color coordinate reference information and the brightness reference information corresponding to the current/voltage of the light-emitting diodes. The control module receives the color coordinate requirement information and the brightness requirement information corresponding to the light-emitting diodes, and uses the color coordinate reference information, the brightness reference information, the color coordinate requirement information, and the brightness requirement information according to the light mixing algorithm to generate the first control signal. The driving module generates the driving signal according to the first control signal, so as to drive the light-emitting diodes to emit a light having a color coordinate and brightness that meets requirements. Therefore, the light-emitting diode device of the disclosure performs color calibration through real-time calculation, providing users with real-time and reliable color (light) adjustment combinations, thereby improving the traditional shortcomings of needing to spend a lot of time in advance to classify the light-emitting diodes (for example, binning) and then select appropriate light-emitting diodes for packing in light-emitting devices, saving LED component screening costs and reducing LED inventory, improving the production yield and simplicity of surface mount technology. There is no need to perform complicated color calibration and white balance adjustment in advance, so as to increase the convenience of use.

While the disclosure has been described by way of example and in terms of the embodiments, it should be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A light-emitting diode device, comprising:
a plurality of light-emitting diodes, configured to emit different colors of light;
a storage module, configured to pre-store color coordinate reference information and brightness reference information corresponding to a current/voltage of the plurality of light-emitting diodes;
a control module, coupled to the storage module, wherein the control module is configured to receive color coordinate requirement information and brightness requirement information corresponding to the plurality of light-emitting diodes, and generate a first control signal based on the color coordinate reference information, the brightness reference information, the color coordinate requirement information and the brightness requirement information according to a light mixing algorithm;
a driving module, coupled to the plurality of light-emitting diodes and the control module, wherein the driving module is configured to generate a driving signal according to the first control signal, so as to drive the plurality of light-emitting diodes to emit a light having a color coordinate and brightness that meet requirements; and
a package structure, configured to accommodate the plurality of light-emitting diodes, the storage module, the control module and the driving module.

2. The light-emitting diode device according to claim 1, wherein the color coordinate requirement information comprises an X-axis color coordinate value and a Y-axis color coordinate value, and the brightness requirement information comprises a desired light intensity value.

3. The light-emitting diode device according to claim 2, wherein the plurality of light-emitting diodes comprises a red light-emitting diode, a green light-emitting diode and a blue light-emitting diode, the color coordinate reference information comprises a predetermined red light X-axis color coordinate value, a predetermined red light Y-axis color coordinate value, a predetermined green light X-axis color coordinate value, a predetermined green light Y-axis color coordinate value, a predetermined blue light X-axis color coordinate value and a predetermined blue light Y-axis color coordinate value, and the brightness requirement information comprises a predetermined red light intensity value, a predetermined green light intensity value and a predetermined blue light intensity value.

4. The light-emitting diode device according to claim 3, wherein the control module is configured to calculate a desired red light intensity value, a desired green light intensity value and a desired blue light intensity value according to the light mixing algorithm;
wherein the control module is configured to calculate a first duty cycle of a first pulse width modulation signal corresponding to the red light-emitting diode according to the desired red light intensity value and the predetermined red light intensity value, calculate a second duty cycle of a second pulse width modulation signal corresponding to the green light-emitting diode according to the desired green light intensity value and the predetermined green light intensity value, and calculate a third duty cycle of a third pulse width modulation signal corresponding to the blue light-emitting diode according to the desired blue light intensity value and the predetermined blue light intensity value;
wherein the driving module is configured to respectively drive the red light-emitting diode, the green light-emitting diode and the blue light-emitting diode according to the first duty cycle of the first pulse width modulation signal, the second duty cycle of the second pulse width modulation signal and the third duty cycle of the third pulse width modulation signal.

5. The light-emitting diode device according to claim 4, wherein the control module is configured to convert the X-axis color coordinate value, the Y-axis color coordinate value and the desired light intensity value into a first stimulation value, a second stimulation value and a third stimulation value, and substitute the first stimulation value, the second stimulation value, the third stimulation value, the predetermined red light X-axis color coordinate value, the predetermined red light Y-axis color coordinate value, the predetermined green light X-axis color coordinate value, the predetermined green light Y-axis color coordinate value, the predetermined blue light X-axis color coordinate value, and the predetermined blue light Y-axis color coordinate value into equations (1), (2) and (3) of the light mixing algorithm, so as to obtain the desired red light intensity value, the desired green light intensity value and the desired blue light intensity value;
$${I}_{{r\_desired}^{}} * {x}_{r} / {y}_{r} + {I}_{g\_desired} * {x}_{g} / {y}_{g} + {I}_{b\_desired} * {x}_{b} / {y}_{b} = X ; \qquad ( 1 )$$
$${I}_{{r\_desired}^{}} + {I}_{g\_desired} + {I}_{b\_desired} = Y ; \qquad ( 2 )$$
$$and$$
$${I}_{r\_desired} ( 1 - {x}_{r} - {y}_{r} ) / {y}_{r} + {I}_{g\_desired} ( 1 - {x}_{g} - {y}_{g} ) / {y}_{g} + {I}_{b\_desired} ( 1 - {x}_{b} - {y}_{b} ) / {y}_{b} = Z , \qquad ( 3 )$$
wherein X is the first stimulation value, Y is the second stimulation value, Z is the third stimulation value, xᵣ is the predetermined red light X-axis color coordinate value, yᵣ is the predetermined red light Y-axis color coordinate value, x_{g} is the predetermined green light X-axis color coordinate value, y_{g} is the predetermined green light Y-axis color coordinate value, x_{b} is the predetermined blue light X-axis color coordinate value, y_{b} is the predetermined blue light Y-axis color coordinate value, I_{r_desired} is the desired red light intensity value, I_{g_desired} is the desired green light intensity value, and I_{b_desired} is the desired blue light intensity value.

6. The light-emitting diode device according to claim 1, wherein the storage module is further configured to pre-store thermal characteristic information of the plurality of light-emitting diodes, and the light-emitting diode device further comprises:
a temperature-sensing module, configured to sense a temperature of the plurality of light-emitting diodes to generate a temperature signal;
wherein the control module is configured to receive the temperature signal, and use the temperature signal and the thermal characteristic information according to a thermal decay compensation algorithm to generate a second control signal;
wherein the driving module is further configured to adjust the driving signal according to the second control signal.

7. The light-emitting diode device according to claim 6, wherein the thermal characteristic information comprises a corresponding relationship between the temperature and the brightness of the plurality of light-emitting diodes.

8. The light-emitting diode device according to claim 7, wherein the control module is configured to calculate a red light intensity thermal decay compensation value ΔIᵣ, a green light intensity thermal decay compensation value ΔI_{g} and a blue light intensity thermal decay compensation value ΔI_{b} according to the temperature signal and the thermal decay compensation algorithm;
wherein the control module is configured to generate a first duty cycle compensation value corresponding to the first pulse width modulation signal of the red light-emitting diode, a second duty cycle compensation value corresponding to the second pulse width modulation signal of the green light-emitting diode and a third duty cycle compensation value corresponding to the third pulse width modulation signal of the blue light-emitting diode for the second control signal according to the red light intensity thermal decay compensation value ΔIᵣ, the green light intensity thermal decay compensation value ΔI_{g} and the blue light intensity thermal decay compensation value ΔI_{b}.

9. The light-emitting diode device according to claim 8, wherein the thermal decay compensation algorithm comprises equations (4) and (5):
$${I}_{r , g , b} ( T ) = a T + b ; \qquad ( 4 )$$
$$and$$
$$Δ {I}_{r , g , b} = {I}_{r , g , b} ( Ts ) - {I}_{r , g , b} ( T ) ; \qquad ( 5 )$$
wherein a is a slope, b is an offset value, T is a temperature corresponding to the plurality of light-emitting diodes, Ts is a criterion temperature, I_{r,g,b}(T) denotes a thermal decay light intensity value Iᵣ(T), I_{g}(T) and I_{b}(T) corresponding to the red light-emitting diode, the green light-emitting diode and the blue light-emitting diode at the temperature T, I_{r,g,b}(Ts) denotes a criterion red light intensity value Iᵣ(Ts), a criterion green light intensity value I_{g}(Ts) and a criterion blue light intensity value I_{b}(Ts) corresponding to the red light-emitting diode, the green light-emitting diode and the blue light-emitting diode at the criterion temperature Ts, and ΔI_{r,g,b} denotes the red light intensity thermal decay compensation value ΔIᵣ, the green light intensity thermal decay compensation value ΔI_{g} and the blue light intensity thermal decay compensation value ΔI_{b}.

10. The light-emitting diode device according to claim 9, wherein the control module is configured to calculate the first duty cycle compensation value corresponding to the first pulse width modulation signal of the red light-emitting diode, the second duty cycle compensation value corresponding to the second pulse width modulation signal of the green light-emitting diode and the third duty cycle compensation value corresponding to the third pulse width modulation signal of the blue light-emitting diode according to a ratio of the red light intensity thermal decay compensation value to the criterion red light intensity value, a ratio of the green light intensity thermal decay compensation value to the criterion green light intensity value and a ratio of the blue light intensity thermal decay compensation value to the criterion blue light intensity value;
wherein the driving module is configured to adjust the driving signal according to the first duty cycle compensation value, the second duty cycle compensation value and the third duty cycle compensation value.
